(19) United States
(12) Patent Application Publication
(10) Pub. No.: US 2019/0377253 A1
(43) Pub. Date: Dec. 12, 2019

(54) WRITABLE PROJECTION SCREEN

(71) Applicant: Nano Precision Taiwan Limited, Hsinchu County (TW)

(72) Inventors: FANG-HSUAN SU, HSINCHU COUNTY (TW); CHIA-HUA CHEN, HSINCHU COUNTY (TW); FU-CHIANG HSU, HSINCHU COUNTY (TW); CHIH-NENG TSENG, HSINCHU COUNTY (TW); CHI-TANG HSIEH, HSINCHU COUNTY (TW)

(21) Appl. No.: 16/381,000

(22) Filed: Apr. 10, 2019

(30) Foreign Application Priority Data
Jun. 11, 2018 (CN) 201810596491.9

(51) Int. Cl. G03B 21/20; G03B 21/62; G06F 3/041; G06F 3/044

(52) U.S. Cl. CPC G03B 21/2066; G06F 3/044; G06F 3/0412; G03B 21/62

(57) ABSTRACT

A writable projection screen includes a substrate, a reflective layer and a writing layer. The reflective layer is disposed on the substrate, and the writing layer has a light receiving surface. The light receiving surface is adapted to receive a projection light beam. A roughness of the light receiving surface is between 5 μm and 30 μm. The substrate is disposed between the reflective layer and the writing layer, or the reflective layer is disposed between the substrate and the writing layer. The writable projection screen has good quality for displaying an image and can be used for being written by a variety of pens.

### CROSS-REFERENCE TO RELATED APPLICATION

THIS APPLICATION CLAIMS THE PRIORITY BENEFIT OF CHINA APPLICATION (CN201810596491.9 FILED ON 2018 Jun. 11). THE ENTIRETY OF THE ABOVE-MENTIONED PATENT APPLICATION IS HEREBY INCORPORATED BY REFERENCE HEREIN AND MADE A PART OF THIS SPECIFICATION.

### FIELD OF THE INVENTION

The invention relates to a projection screen, and more particularly to a writable projection screen.

### BACKGROUND OF THE INVENTION

In current days, blackboards can be manufactured by few processes. In one process of manufacturing blackboards, a wood substrate coated with blackboard paint material is heated in an oven. Since the wood substrate is hard, the substrate cannot be curled. Therefore the blackboards manufactured by this one process are inconvenient to carry while its size is too large. In another process of manufacturing blackboards, a cement wall is painted with two or more layers of blackboard paints material, and blackboards can be used after a few days of drying. However, the operation of this manufacturing process must be limited by a specific substrate, thus there are a lot of manufacturing bottlenecks.

On the other hand, due to the substrate of current blackboards is a wooden board or a cement wall, and the background color of the blackboards is dark green, the current blackboards as a projection screen fails to provide a gain function to the projected light. As a result, visual sense and color saturation of the projected image are affected, and then color distortion thereof is distorted.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

The invention provides a writable projection screen, which has good display quality and can be written by a variety of pens.

Other advantages and objects of the invention may be further illustrated by the technical features broadly embodied and described as follows.

In order to achieve one or part or all of the objects or other objects, an embodiment of the invention provides a writable projection screen, which includes a substrate, a reflective layer and a writing layer. The reflective layer is disposed on the substrate. The writing layer has a light receiving surface. The light receiving surface is adapted to receive a projection light beam. A roughness of the light receiving surface is between 5 μm and 30 μm. The substrate is disposed between the reflective layer and the writing layer, or the reflective layer is disposed between the substrate and the writing layer.

According to the above, the writable projection screen of the embodiment of the invention includes a reflective layer, and the reflective layer is used to reflect the projection light beam, thus, the reflection effect is better and the display quality can be improved. Furthermore, the roughness of the light receiving surface of the writing layer is between 5 μm and 30 μm, so as to facilitate the writing layer to be written by various types of pens, such as chalk, water brush (gouache), white board marker, crayons, etc. Besides replacing a traditional whiteboard and blackboard, the writable projection screen of the embodiment of the invention further provides an anti-glare effect when displaying a projected image.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a writable projection screen receiving a projection light beam according to an embodiment of the invention;

FIG. 2 is a schematic view of a writable projection screen according to another embodiment of the invention;

FIG. 3 is a schematic view of a writable projection screen according to another embodiment of the invention; and

FIG. 4 is a schematic view of a writable projection screen according to another embodiment of the invention.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

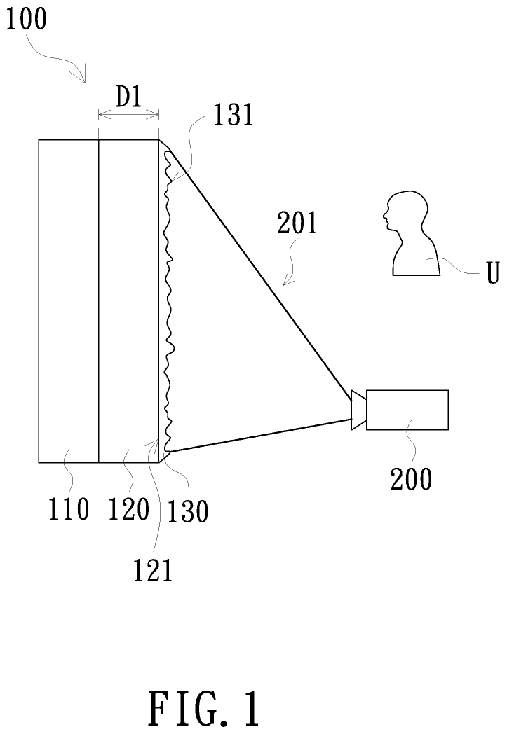

FIG. 1 is a schematic view of a writable projection screen receiving a projection light beam according to an embodiment of the invention. Referring to FIG. 1, the writable projection screen 100 of the embodiment includes a substrate 110, a reflective layer 120 and a writing layer 130. The reflective layer 120 is disposed on the substrate 110. In the embodiment, the reflective layer 120 is disposed between the substrate 110 and the writing layer 130, for example. The writing layer 130 has a light receiving surface 131, and the light receiving surface 131 is adapted to receive the projection light beam 201 projected by a projector 200.

In the embodiment, the projection light beam 201 passes through the light receiving surface 131 and is reflected by the reflective layer 120 to allow the user U to see the projected image. The reflective layer 120 is, for example, a reflective pigment layer. The weight percentage of the pigment in the reflective pigment layer is, for example, greater than or equal to 50 wt %, and the thickness D1 of the reflective layer 120 is, for example, greater than or equal to 20 μm, but is not limited thereto. The thickness D1 of the reflective layer 120 can be adjusted depending on the weight percentage of the pigment. The pigment may be selected from at least one under visible light shown red, green, blue, white pigments, but is not limited thereto. In an embodiment, the selected color of pigment may be a pale color such as carnation, pale green and pale blue under visible light. In the embodiment, by the adjustment of the pigment color and the thickness D1, the writable projection screen 100 can provide a better color saturation when displaying the projected image and avoid color distortion which may affect the visual feeling of the user U. Therefore, the writable projection screen 100 has a good display effect. Further, the surface 121 of the reflective layer 120 facing the writing layer 130 is, for example, a flat surface to enhance the display effect. In the embodiment, the surface 121 of the reflective layer 120 is located between the light receiving surface 131 of the writing layer 130 and the substrate 110. In addition, the material of the reflective layer 120 may include a photocurable material (e.g., photocurable resin), but is not limited thereto. In the embodiment, in a process of manufacturing blackboards, a chemical compound (e.g., photocurable resin, that is, a material forming the reflective layer 120) is coated on the substrate 110, and then a photocuring process is performed to form the reflective layer 120, but is not limited thereto.

In the embodiment, the thickness of the writing layer 130 is, for example, less than or equal to 40 μm. In an embodiment, the thickness of the writing layer 130 is, for example, between 7 μm and 40 μm. The writing layer 130 is, for example, a transparent writing layer, but a pigment may be added to the writing layer 130 as needed. The light receiving surface 131 of the writing layer 130 may have a pattern, and the light receiving surface 131 having the pattern is a rough surface. The roughness of the light receiving surface 131 of the writing layer 130 is between 5 μm and 30 μm, so that the user U can easily write on the writing layer 130 by using various types of pens such as chalk, water brush (gouache), white board marker, crayons and the like. There is a problem of difficult writing if the roughness is less than 5 μm, and there is a problem of difficult wiping if the roughness is greater than 30 μm. Since the writing layer 130 can be written by chalk or white board marker, the writable projection screen 100 of the embodiment can be used as both a blackboard and a whiteboard. The above chalk includes various chalks such as traditional chalk (the main component includes calcium sulfate), environmental chalk (the main component includes calcium carbonate), and water-wiping chalk and so on. In an embodiment, the roughness of the light receiving surface 131 may be between 5 μm and 15 μm to facilitate the white board marker written and wiped. Further, since the light receiving surface 131 has the roughness described above, it is possible to have an anti-glare effect when receiving the projection light beam 201, so as to prevent the user U from being glare when viewing. In the embodiment, the roughness of the light receiving surface 131 is, for example, positively correlated with respect to the degree of anti-glare.

In order to provide the writing layer 130 with better durability, the hardness of the writing layer 130 is, for example, greater than or equal to 3H/500 g, or even greater than or equal to 3H/765 g. The hardness here is measured by a pencil scratch hardness tester, wherein 3H indicates that the pencil has a hardness of 3H, and 500 g indicates that the pencil has a load of 500 g. The writing layer 130 having a hardness of 3H/500 g represents that the writing layer 130 will not be damaged when a pen having a hardness of 3H writes on the writing layer 130 under a load of 500 g. The material of the writing layer 130 may be selected from a hard rubber such as Acrylic, but not limited thereto. Further, the material of the writing layer 130 includes, for example, a photocurable material (e.g., photocurable resin), but is not limited thereto. In the embodiment, in a process of manufacturing blackboards, a chemical compound (e.g., photocurable resin, that is, a material forming the writing layer 130) may be coated on the substrate 110, and then a photocuring process is performed to form the above-described writing layer 130. In addition, the material of the writing layer 130 may further include an anti-fingerprint material, for example including at least one of fluoride and silicide, to prevent fingerprints from remaining on the writing layer 130.

The substrate 110 described above may be a flexible substrate or a rigid substrate, wherein the flexible substrate can be furled, which provides an advantage of the writable projection screen 100 to being easy moved. In addition, in the embodiment, the substrate 110 is a flexible substrate, the reflective layer 120 and the writing layer 130 may be formed on the substrate 110 in a roll-to-roll manner, and the material forming the reflective layer 120 and the writing layer 130 may be a photocurable material, but is not limited thereto. Thus, the writable projection screen 100 of the embodiment provides advantages such as being quick to produce, mass production, and arbitrarily cut into required size. In an embodiment, the substrate 110 may be a light transmissive substrate or an opaque substrate, and the embodiment does not limit the color of the opaque substrate.

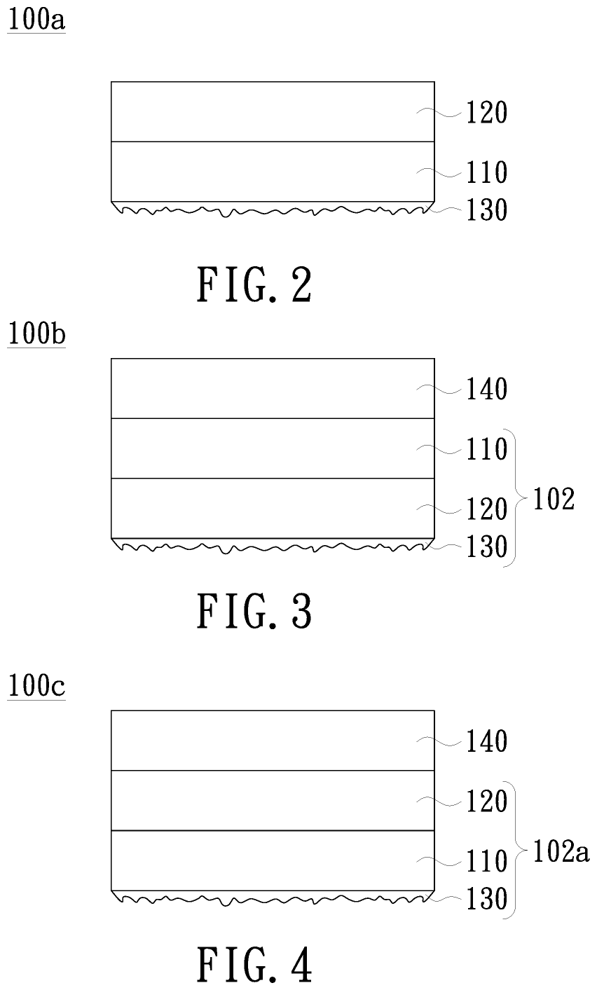

The reflective layer 120 is disposed between the substrate 110 and the writing layer 130 in FIG. 1. However, in another embodiment as shown in the writable projection screen 100a of FIG. 2, the substrate 110 may be disposed between the reflective layer 120 and the writing layer 130. Referring to FIG. 2, the substrate 110 is, for example, a light transmissive substrate to allow a projection light beam to pass therethrough.

FIG. 3 is a schematic view of a writable projection screen according to another embodiment of the invention. Referring to FIG. 3, the writable projection screen 100b of the embodiment is similar to the writable projection screen 100 of FIG. 1, and the main difference is that the writable projection screen 100b of the embodiment further includes a touch sensor film 140, wherein the substrate 110 and the reflective layer 120 are disposed between the touch sensor film 140 and the writing layer 130. The touch sensor film 140 is, for example, attached to the side of the stacked structure 102 away from the writing layer 130 after the stacked structure 102 composed of the substrate 110, the reflective layer 120 and the writing layer 130 is completed. The touch sensor film 140 can be a capacitive touch sensor film or an electromagnetic touch sensor film. The capacitive touch sensor film can sense writing and operation of, for example, a finger or a conductive pen, and the electromagnetic touch sensor film can sense writing and operation of, for example, an electromagnetic stylus. In the embodiment, the touch sensor film 140 has, for example, a chip processor (not shown). The chip processor is electrically connected to a computer to transmit the sensed touch signal to the computer, but is not limited thereto. In this way, the writable projection screen 100b of the embodiment can be used not simply for the user to write, but as a touchable projection screen.

The touch sensor film 140 described above may also be applied to the writable projection screen 100a described above. As shown in FIG. 4, the touch sensor film 140 of the writable projection screen 100c is, for example, attached to the side of the stacked structure 102a away from the writing layer 130 after the stacked structure 102a composed of the substrate 110, the reflective layer 120 and the writing layer 130 is completed.

As stated above, the writable projection screen of the embodiment of the invention includes a reflective layer used to reflect the projection light beam, and thus the reflection effect is better and the display quality can be improved. In addition, since the roughness of the light receiving surface of the writing layer is between 5 μm and 30 μm, various types of pens can be provided for writing, such as chalk, water brush (gouache), white board marker, crayons, etc. Besides replacing a traditional whiteboard and blackboard, the writable projection screen of the embodiment of the invention further provides an anti-glare effect when displaying a projected image.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A writable projection screen, comprising:
a substrate;
a reflective layer, disposed on the substrate; and
a writing layer, having a light receiving surface, wherein the light receiving surface is adapted to receive a projection light beam, and a roughness of the light receiving surface is between 5 μm and 30 μm,
wherein the substrate is disposed between the reflective layer and the writing layer, or the reflective layer is disposed between the substrate and the writing layer.

2. The writable projection screen of claim 1, wherein the substrate is a flexible substrate.

3. The writable projection screen of claim 1, wherein a thickness of the reflective layer is greater than or equal to 20 μm.

4. The writable projection screen of claim 1, wherein the reflective layer is a reflective pigment layer, and a weight percentage of a pigment in the reflective pigment layer is greater than or equal to 50 wt %.

5. The writable projection screen of claim 1, wherein a material of the reflective layer comprises a photocurable resin.

6. The writable projection screen of claim 1, wherein a thickness of the writing layer is between 7 μm and 40 μm.

7. The writable projection screen of claim 1, wherein the roughness of the light receiving surface is between 5 μm and 15 μm.

8. The writable projection screen of claim 1, wherein the writing layer is a transparent writing layer.

9. The writable projection screen of claim 1, wherein a material of the writing layer comprises a photocurable resin.

10. The writable projection screen of claim 9, wherein the material of the writing layer further comprises at least one of fluoride and silicide.

11. The writable projection screen of claim 1, wherein a hardness of the writing layer is greater than or equal to 3H/500 g.

12. The writable projection screen of claim 1, further comprising a touch sensor film, wherein the substrate and the reflective layer are disposed between the touch sensor film and the writing layer, and the touch sensor film is a capacitive touch sensor film or an electromagnetic touch sensor film.
